(19) United States
(12) Patent Application Publication
(10) Pub. No.: US 2005/0163224 A1
(43) Pub. Date: Jul. 28, 2005

(54) Device and method for playing back scalable video streams

(75) Inventors: Sung-chol Shin, Suwon-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/033,565

(22) Filed: Jan. 12, 2005

(30) Foreign Application Priority Data
Jan. 28, 2004 (KR) 10-2004-0005482

(51) Int. Cl. H04N 7/12

(52) U.S. Cl. 375/240.25; 375/240.03; 375/240.18

(57) ABSTRACT

A device and method for playing back scalable video streams. The device for playing back a scalable video stream includes a screen mode determination unit that determines the mode of a screen to be displayed, a decoding level determination unit that determines a decoding level according to the screen mode, a predecoder that provides a signal to be decoded in accordance with the decoding level, a decoder that decodes the signal provided by the predecoder, and a display unit that displays the decoded signal. The method includes judging the mode of a screen to be displayed, determining a decoding level suitable for the mode of the screen, performing predecoding in order to provide a signal to be decoded according to the decoding level, decoding the signal provided by the predecoder, and displaying the decoded signal for playback.

### CROSS-REFERENCE TO RELATED APPLICATION

This application claims priority from Korean Patent Application No. 10-2004-0005482 filed on Jan. 28, 2004 in the Korean Intellectual Property Office, the disclosure of which is incorporated herein by reference in its entirety.

### BACKGROUND OF THE INVENTION

1. Field of the Invention

The present invention relates to a device and a method for playing back scalable video streams, and more particularly, to a device and a method for playing back scalable video streams, which are designed to reduce the amount of computation of a decoder by checking the size of a screen to be displayed on a display that outputs multiple screens, determining a decoding level according to the size, and performing predecoding according to the determined decoding level.

2. Description of the Related Art

With the development of information communication technology including the Internet, the use of video communication, as well as text and voice communication, has increased.

Conventional text communication cannot satisfy the various demands of users, and thus multimedia services that can provide various types of information such as text, pictures, and music have increased.

Multimedia data requires a large capacity storage medium and a wide bandwidth for transmission since the amount of multimedia data is usually large. Accordingly, a compression coding method is a requisite for transmitting multimedia data including text, video, and audio.

A basic principle of data compression is removing data redundancy.

Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency.

Data compression can be classified into lossy/lossless compression according to whether source data is lost, intraframe/interframe compression according to whether individual frames are compressed independently, and symmetric/asymmetric compression according to whether time required for compression is the same as time required for recovery.

Data compression is defined as real-time compression when a compression/recovery time delay does not exceed 50 ms and as scalable compression when frames have different resolutions. For text or medical data, lossless compression is usually used. For multimedia data, lossy compression is usually used.

Meanwhile, intraframe compression is usually used to remove spatial redundancy, and interframe compression is usually used to remove temporal redundancy.

Different types of transmission media for multimedia have different performance.

Currently used transmission media have various transmission rates. For example, an ultrahigh-speed communication network can transmit data of several tens of megabits per second, while a mobile communication network has a transmission rate of 384 kilobits per second.

In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream, since they use a reflexive approach in a main algorithm.

Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream.

Scalability includes spatial scalability indicating a video resolution, Signal to Noise Ratio (SNR) scalability indicating a video quality level, temporal scalability indicating a frame rate, and combinations thereof.

That is, current scalable video codecs enable a signal received from a decoder terminal to be decoded at a desired quality level, spatial resolution, and frame rate, or a combination of these factors. Thus, if the size of a screen varies on a TV or other display system, scalable video coding techniques are used to adjust the decoding level, thereby decreasing system power consumption while increasing efficient resource utilization.

A conventional display device that can display multiple screens (for example, a Picture-in-Picture (PIP) function) decodes the entire signal and performs scaling thereon. That is, to display a video signal on an entire screen or a sub screen, the entire encoded signal must be decoded.

For display on a sub screen, however, it is efficient to decode a specific bitstream instead of the entire video signal in accordance with the size of the sub screen and the environment of a display device. Nevertheless, there is still insufficient research to adjust a resolution depending on the size of a screen.

Thus, in a video decoding scheme supporting spatial scalability, it is highly desirable to create a method for changing a resolution depending on the size of a screen for playing back a bitstream.

### SUMMARY OF THE INVENTION

The present invention provides a method and device for stably providing video streaming services in low network bandwidth environments by reducing the amount of computation of a decoder, which is possible by determining a decoding level according to the size of a screen to be displayed on a display and performing predecoding according to the determined decoding level.

According to an exemplary embodiment of the present invention, there is provided a device for playing back a scalable video stream, the device including a screen mode determination unit that determines the mode of a screen to be displayed, a decoding level determination unit that determines a decoding level according to the mode, a predecoder that provides a signal to be decoded in accordance with the decoding level, a decoder that decodes the signal provided by the predecoder, and a display unit that displays the decoded signal.

The screen mode determination unit checks whether the screen mode is a main or sub screen of a Picture-in-Picture (PIP), and checks the size of a screen to be displayed.

The decoding level determination unit may determine the decoding level considering whether the quality of the screen to be displayed coincides with user's subjective perception of quality, and resolution and frame rate of the screen. Also, the decoding level determination unit may determine the decoding level in consideration of the resolution of the screen to be displayed. Further, the decoding level determination unit may determine the decoding level in consideration of the playback speed of the screen to be displayed.

According to another exemplary embodiment of the present invention, there is provided a method for playing back a scalable video stream, the method including judging the mode of a screen to be displayed, determining a decoding level suitable for the mode, performing predecoding in order to provide a signal to be decoded according to the decoding level, decoding the signal provided by the predecoder, and displaying the decoded signal for playback.

The decoding level may be determined considering whether the quality of the screen to be displayed coincides with a user's subjective perception of quality, and resolution and frame rate of the screen. Also, the decoding level may be determined in consideration of the resolution or the playback speed of the screen to be displayed.

The displaying of the decoded signal for playback may comprise inversely quantizing information on the decoded signal to obtain transform coefficients, and performing inverse spatial and temporal transformation on the transform coefficients.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram showing the configuration of an encoder according to an exemplary embodiment of the present invention;

FIG. 2 schematically illustrates a temporal decomposition process in scalable video coding and decoding based on Motion Compensated Temporal Filtering (MCTF) according to an exemplary embodiment of the present invention;

FIG. 3 schematically illustrates a process of decomposing an input image or frame into subbands by wavelet transformation according to an exemplary embodiment of the present invention;

FIG. 4 is a schematic block diagram of a decoder according to an exemplary embodiment of the present invention;

FIG. 5 is a block diagram of a playback device for playing back a scalable video stream according to an exemplary embodiment of the present invention; and

FIG. 6 is a flowchart schematically illustrating a method for playing back a scalable video stream according to an exemplary embodiment of the present invention.

### DETAILED DESCRIPTION OF THE ILLUSTRATIVE, NON-LIMITING EMBODIMENTS OF THE INVENTION

The advantages and features of the present invention and methods for accomplishing the same will now be described more fully with reference to the accompanying drawings, in which exemplary embodiments of the invention are shown. This invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the same reference numerals in different drawings represent the same element.

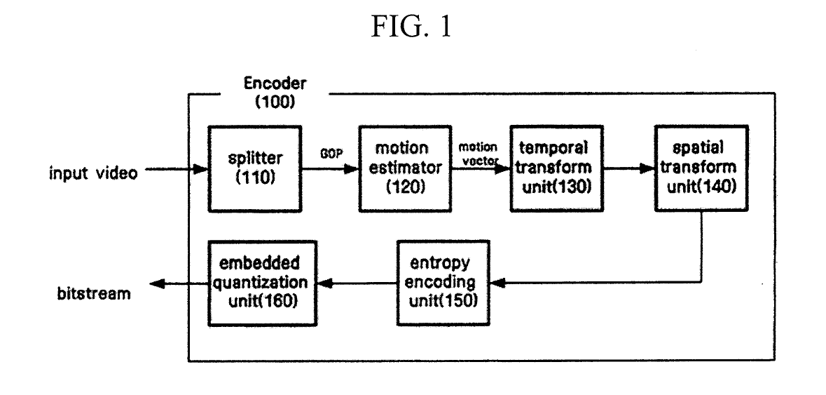

Referring to FIG. 1, an encoder 100 according to an exemplary embodiment of the present invention includes a segmenting unit 110, a motion estimation unit 120, a temporal transform unit 130, a spatial transform unit 140, an embedded quantization unit 150, and an entropy encoder 160.

The segmenting unit 110 divides an input video into basic encoding units, i.e., groups of pictures (GOPs).

The motion estimation unit 120 compares each macroblock in a current frame being subjected to motion estimation with each macroblock in a corresponding reference frame to find the best matched macroblock, thereby obtaining the optimal motion vector. A hierarchical method such as a Hierarchical Variable Size Block Matching (HVSBM) may be used to implement the motion estimation.

The temporal transform unit 130 decomposes frames into low- and high-frequency frames in a temporal direction using the motion vector obtained by the motion estimation unit 120, thereby reducing temporal redundancy.

For example, an average of frames may be defined as a low-frequency component, and half of a difference between two frames may be defined as a high-frequency component. Frames are decomposed in units of GOPs. Frames may be decomposed into high- and low-frequency frames by comparing pixels at the same positions in two frames without using a motion vector. However, the method not using a motion vector is less effective in reducing temporal redundancy than the method using a motion vector.

In other words, when a portion of a first frame is moved in a second frame, an amount of a motion can be represented by a motion vector. The portion of the first frame is compared with a portion to which a portion of the second frame at the same position as the portion of the first frame is moved by the motion vector, that is, a temporal motion is compensated. Thereafter, the first and second frames are decomposed into low- and high-frequency frames.

Motion Compensated Temporal Filtering (MCTF) or Unconstrained MCTF (UMCTF) may be used for temporal filtering.

The spatial transform unit 140 removes spatial redundancies from the frames from which the temporal redundancies have been removed by the temporal transform unit 130, and creates transform coefficients.

For spatial transformation, the present invention uses a wavelet transform. Here, the wavelet transform is used to decompose a frame into low and high frequency subbands and determine transform coefficients, i.e., wavelet coefficients for the respective subbands.

More specifically, the frame is decomposed into four portions. A quarter-sized image (L image) that is similar to the entire image appears in the upper left portion of the frame and information (H image) needed to reconstruct the entire image from the L image appears in the other three portions.

In the same way, the L frame may be decomposed into a quarter-sized LL image and information needed to reconstruct the L image.

Image compression using the wavelet transform is applied to the JPEG 2000 standard and removes spatial redundancies between frames.

Furthermore, the wavelet transform enables the original image information to be stored in the transformed image that is a reduced version of the original image, in contrast to a Discrete Cosine Transform (DCT) method, thereby allowing video coding that provides spatial scalability using the reduced image.

The embedded quantization unit 150 performs embedded quantization on the wavelet coefficients obtained by the spatial transform unit 140 for each wavelet block and rearranges the quantized coefficients according to significance. Here, the significance means the magnitude of the wavelet coefficient obtained after wavelet transform by the spatial transform unit 140. Thus, as the magnitude of wavelet coefficients increases, the significance level also increases. The embedded quantization unit 150 compares the magnitudes of the wavelet coefficients, reorders the coefficients by magnitude, and transmits the wavelet coefficient with the largest magnitude first. Embedded Zerotrees Wavelet Algorithm (EZW), Set Partitioning in Hierarchical Trees (SPIHT), and Embedded ZeroBlock Coding (EZBC) may be used as algorithms performing embedded quantization on the wavelet coefficients for each wavelet block in this way.

The quantization algorithms use dependency present in dependence on hierarchical spatiotemporal trees, thus achieving higher compression efficiency. The algorithms also make good use of a spatial relation between pixels in a wavelet domain used in the present invention so are suitable for use in the embedded quantization process according to the present invention.

Spatial relationships between pixels are expressed in a tree shape. Effective coding can be carried out using the fact that when a root in the tree is 0, children in the tree have a high probability of being 0. While pixels having relevancy to a pixel in the L band are being scanned, algorithms are performed.

The entropy encoding unit 160 converts the wavelet coefficient quantized by the embedded quantization unit 150 and information regarding motion vector and header information generated by the motion estimator 120 into a compressed bitstream suitable for transmission or storage. The entropy encoding may be performed using predictive coding, variable-length coding (e.g., Huffman coding), arithmetic coding, etc.

The present invention can be applied to moving videos as well as still images. Similar to moving video, an input still image may be passed through the spatial transform unit 140, the embedded quantization unit 150, and the entropy encoding unit 160, and converted into a bitstream.

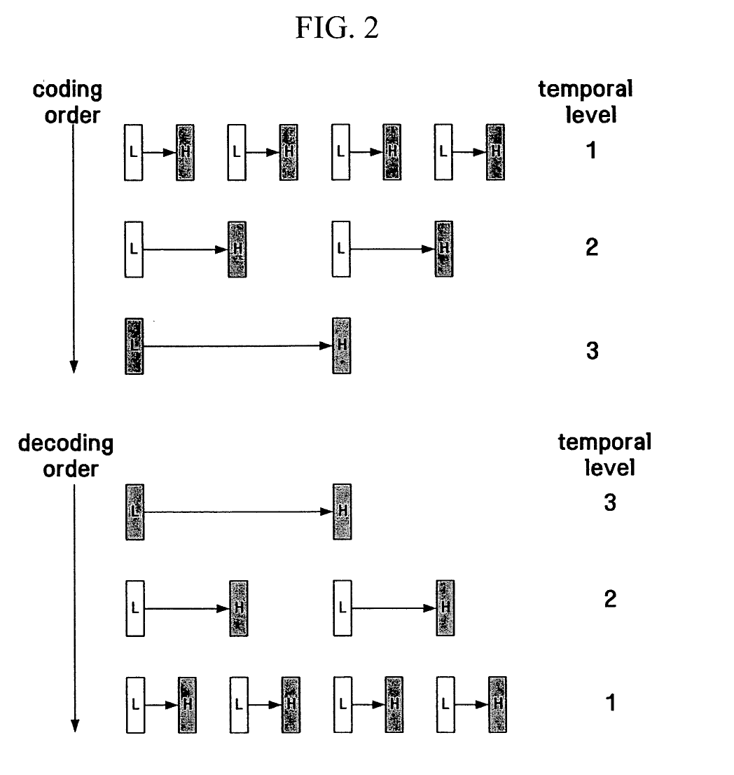

FIG. 2 schematically illustrates a temporal decomposition process in scalable video coding and decoding based on Motion Compensated Temporal Filtering (MCTF) according to an exemplary embodiment of the present invention. Here, an L frame is a low frequency frame corresponding to an average of frames while an H frame is a high frequency frame corresponding to a difference between frames.

In a coding process, pairs of frames at a low temporal level are temporally filtered and then decomposed into pairs of L frames and H frames at a higher temporal level, and the pairs of L frames are again temporally filtered and decomposed into frames at a higher temporal level. An encoder performs wavelet transformation on one L frame at the highest temporal level and the H frames and generates a bitstream. Frames indicated by shading in FIG. 2 are ones that are subjected to a wavelet transform.

More specifically, the encoder 100 encodes frames from a low temporal level to a high temporal level, while a decoder performs an inverse operation to the encoder 100 on the frames indicated by shading and obtained by inverse wavelet transformation from a high level to a low level for reconstructions. L and H frames at temporal level 3 are used to reconstruct two L frames at temporal level 2, and the two L frames and two H frames at temporal level 2 are used to reconstruct four L frames at temporal level 1.

Finally, the four L frames and four H frames at temporal level 1 are used to reconstruct eight frames.

The exemplary embodiments of the present invention allow only a portion of scalable video streams to be decoded by adjusting a temporal level so that it is suitable for a frame rate set for a predetermined size of a screen. Thus, it is possible to change a frame rate. For example, assuming that the set frame rate for a screen is 4×-speed, frames at temporal level 2 corresponding to 4×-speed can be selected among a video stream coded using MCTF for transmission.

While the present invention has been particularly shown and described with reference to the illustrative embodiment using the MCTF-based video coding scheme, it will be understood by those of ordinary skill in the art that various changes in form and details may be made therein. That is, the present invention may implement various modules designed to change a frame rate by decoding a portion of a scalable video stream coded according to MCTF, UMCTF, or other video coding schemes offering temporal scalability, which is possible by adjusting a temporal level according to a frame rate suitable for a set screen size.

Here, other video coding schemes offering temporal scalability may use Successive Temporal Approximation and Referencing (STAR) that performs temporal transformation at limited temporal levels to control delay time while maintaining temporal scalability as much as possible.

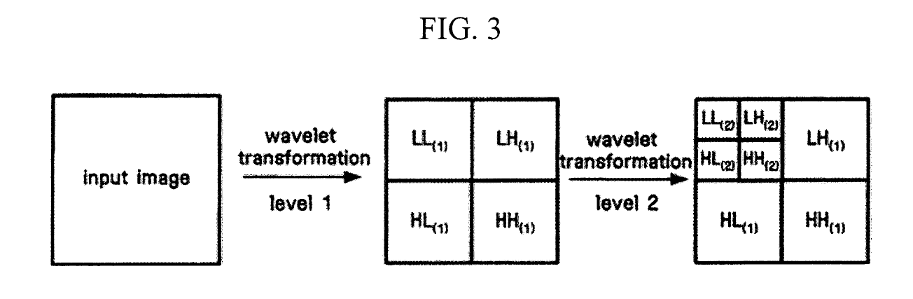

FIG. 3 schematically illustrates a process of decomposing an input image or frame into subbands by wavelet transformation according to an exemplary embodiment of the present invention.

For example, two-level wavelet transformation is performed to decompose the input image or frame into one low frequency subband and three horizontal, vertical, and diagonal high frequency subbands.

The low frequency subband that is low frequency in both the horizontal and vertical directions is referred to as the ‘LL’ subband.

The high frequency subbands in the horizontal, vertical, and both horizontal and vertical directions are referred to as the ‘LH’, ‘HL’, and ‘HH’ subbands, respectively.

The low frequency subband LL is further decomposed iteratively. A number within the parenthesis denotes the level of wavelet transform.

For example, if the size of a screen to be displayed is one fourth of the entire screen, the present invention may allow a bitstream from which information other than subband LL[1] has been removed to be decoded, thus maintaining a low resolution.

A method of processing a scalable bitstream in order to adjust a quality level of a bitstream coded to have a Signal to Noise (SNR) will now be described.

The SNR scalability performs embedded quantization by encoding only pixels having a value greater than a predetermined threshold, decreasing the threshold after encoding, and repeating the above process. The level of quality can be determined by the threshold.

Thus, for a user to generate a bitstream of predetermined quality using a bitstream coded to have SNR scalability, it is necessary to extract a bitstream containing information about pixels with values greater than a given threshold.

To achieve this, an exemplary embodiment of the present invention performs decoding after assigning a threshold required for low quality video suitable for a set screen size and then removing an unnecessary bitstream containing information about pixels with a value greater than the threshold.

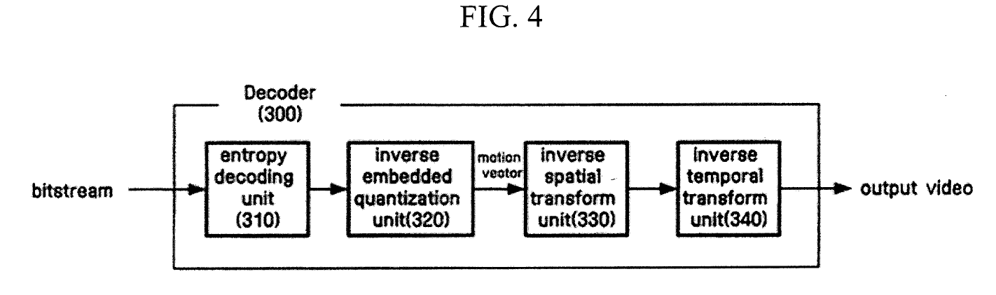

FIG. 4 schematically shows the configuration of a decoder 300 according to an exemplary embodiment of the present invention.

The decoder 300 includes an entropy decoding unit 310, an inverse embedded quantization unit 320, an inverse spatial transform unit 330, and an inverse temporal transform unit 340.

The decoder 300 operates in a substantially reverse direction to the encoder 100. However, while motion estimation has been performed by the motion estimator 120 of the encoder 100 to determine a motion vector, an inverse motion estimation process is not performed by the decoder 300, since the decoder 300 simply receives the motion vector 120 for use.

The entropy decoding unit 310 decomposes the received bitstream for each wavelet block.

The inverse embedded quantization unit 320 performs an inverse operation to the embedded quantization unit 150 in the encoder 100. In other words, wavelet coefficients rearranged for each wavelet block are determined from each decomposed bitstream.

The inverse spatial transform unit 330 then converts the rearranged wavelet coefficients to reconstruct an image in a spatial domain. In this case, inverse wavelet transformation is applied to convert the wavelet coefficients corresponding to each GOP into temporally filtered frames.

The inverse temporal transform unit 340 performs inverse temporal filtering using the frames and motion vectors generated by the encoder 100 and creates a final output video.

As described above in the encoder 100, the present invention can be applied to moving videos as well as still images. Similar to the moving video, the bitstream received from the encoder 100 may be passed through the entropy decoding unit 310, the inverse embedded quantization unit 320, the inverse spatial transform unit 330, and the inverse temporal transform unit 340, and converted into an output image.

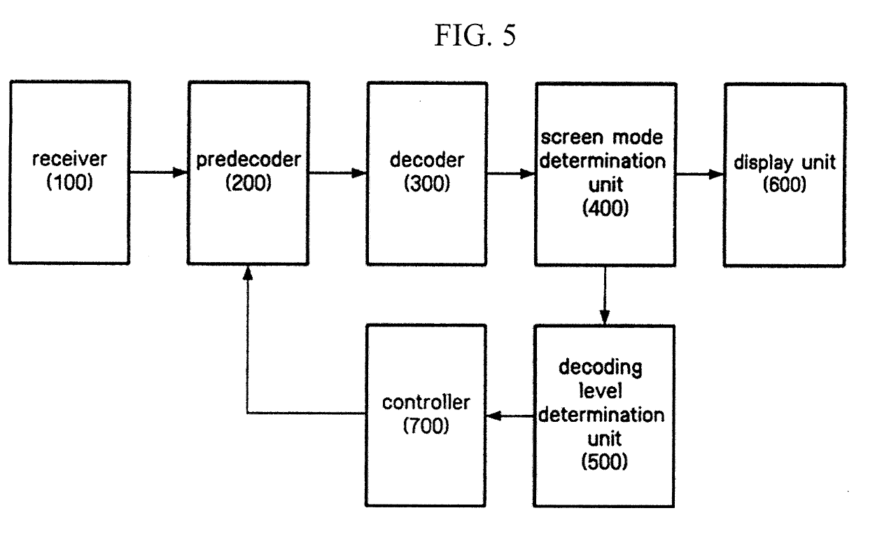

FIG. 5 is a block diagram of a playback device for playing back a scalable video stream according to the present invention. Referring to FIG. 5, the playback device includes a receiver 100, a predecoder 200, a decoder 300, a screen mode determination unit 400, a decoding level determination unit 500, a display unit 600, and a controller 700.

The receiver 100 receives a broadcast or image signal and is composed of multiple tuners and demodulators.

The screen mode determination unit 400 checks the size of a screen mode (main or sub screen) on which a signal decoded in a TV or other displays having a PIP feature is to be displayed in order to determine the mode of the screen being displayed.

The decoding level determination unit 500 determines a decoding level suitable for the screen mode determined by the screen mode determination unit 400 considering the resolution of the screen, quality level, and frame rate. More specifically, the decoding level is determined so that it is suitable for the quality of a screen to be displayed corresponding to a user's subjective perception and the size of a screen mode (main or sub screen) fixed while manufacturing a TV or other display or is arbitrarily determined by the user.

For example, if the size of a screen for playing back the decoded signal is one fourth of the entire screen, a first level of wavelet transform generated by spatial scalability is determined as the decoding level. If the size of the screen is one sixteenth of the entire screen, a second level of wavelet transform generated by spatial scalability is determined as the decoding level. Here, the decoding level determination unit 500 may determine the decoding level considering resolution provided by spatial scalability or a combination of resolution, quality, and frame rate provided by spatial, SNR, and temporal scalabilities, respectively.

The predecoder 200 delivers a signal whose resolution, quality, and frame rate have been adjusted to the decoder 300 as a signal to be decoded according to the decoding level determined by decoding level determination unit 500. The adjustment of the three factors is made by cutting a portion of the received signal in accordance with the decoding level.

For example, the predecoder 200 removes a portion of the signal in such a way that a reconstructed signal satisfies the resolution set according to the decoding level determined by the decoding level determination unit 500, thereby allowing the screen image to be reconstructed at low resolution. Reconstructing the signal at low resolution can decrease the amount of computation of the decoder 300.

In order to decode the signal sent to the predecoder 200, the decoder 300 performs decoding in a reverse order to the order in which the encoder 100 encodes the broadcast signal.

The display unit 600 displays the signal decoded by the decoder 300 on a screen whose size has been determined arbitrarily by the user or fixed during manufacturing.

The controller 700 transmits the decoding level determined by the decoding level determination unit 500 to the predecoder 200 and allows the display unit 600 to display the decoded signal on a screen of a predetermined size. More specifically, once the size of a mode of a screen being displayed has been set, the decoding level determination unit 400 determines a decoding level considering resolution, quality, and frame rate of the screen. The controller 700 transmits the determined decoding level to the predecoder 200, and then a signal decoded by the decoder 300 to the display unit 600, which in turn displays the decoded signal on the screen of the predetermined size.

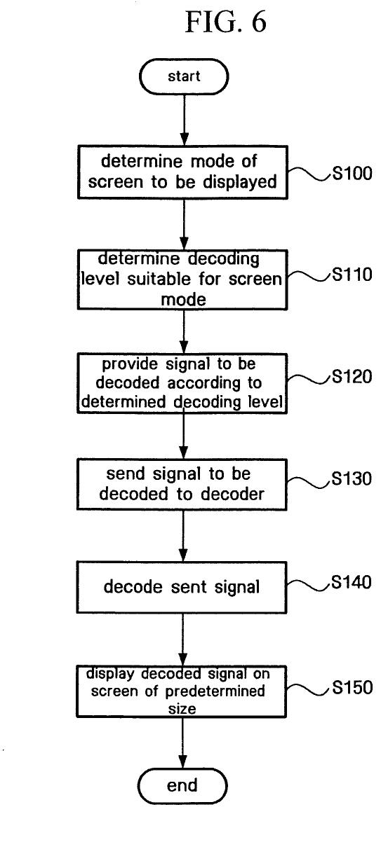

FIG. 6 is a flowchart schematically illustrating a method of playing back a scalable video stream according to the present invention.

Referring to FIG. 6, when a broadcast signal is input, the controller 700 checks whether the input signal is to be displayed on a main (entire) screen or sub screen (of a predetermined size).

Then, in step S100, the screen mode determination unit 400 determines the size of a screen (i.e., main or sub screen) being displayed. Here, the size of the screen being displayed is fixed while manufacturing TVs or other displays or determined arbitrarily by the user.

Next, when the input signal is displayed on the main screen, the controller 700 allows all the input signals to be decoded for display on the main screen.

When the input signal is displayed on the sub screen, the controller 700 delivers the size of the sub screen determined by the screen mode determination unit 400 to the decoding level determination unit 500.

In step S110, the decoding level determination unit 500 then determines a decoding level based on the size of the screen delivered. Here, the decoding level is determined by the resolution, the quality, and the frame rate of the screen to be displayed. That is, the quality of the screen to be displayed is determined such that it is suitable for the size of the screen and the user's subjectively perceived quality.

For example, assuming that the size of the sub screen is one fourth of the entire screen, the decoding level determination unit 500 may determine the first level of wavelet transform as the decoding level.

The controller 700 sends the decoding level determined by the decoding level determination unit 500 to the predecoder 200 that then provides a signal to be decoded among the received signal in step S120. Here, the predecoder 200 cuts a portion of the signal coded using a scalable video coding scheme in such a way as to satisfy the decoding level determined by the decoding level determination unit 500 and provides a signal suitable for the user's subjective perception of quality. In other words, the predecoder 200 removes a portion of the received signal to fit the size of the sub screen, thereby providing a reconstructed image screen that has a low resolution but high quality and frame rate.

In step S130, the controller 700 then sends a signal to be decoded provided by the predecoder 200 to the decoder 300 that in turn performs decoding by inversely quantizing information on the received signal to obtain transform coefficients and then performs inverse spatial and temporal transformation on the transform coefficients in step S140.

In step S150, the controller 700 allows the display unit 600 to display the signal decoded by the decoder 300 on the sub screen.

Although only a few embodiments of the present invention have been shown and described with reference to the attached drawings, it will be understood by those skilled in the art that changes may be made to these elements without departing from the features and spirit of the invention. Therefore, it is to be understood that the above-described embodiments have been provided only in a descriptive sense and will not be construed as placing any limitation on the scope of the invention.

The device and method for playing back a scalable video stream according to the present invention described above have the following advantages.

First, the above-described exemplary embodiments of the device and method of the present invention determine a decoding level according to the size of a screen to be displayed and perform predecoding according to the determined decoding level, thereby reducing the amount of computation of the decoder.

Second, only a portion of a bitstream extracted according to the size of the screen to be displayed is decoded, thereby reducing download time or stably providing video streaming services in low network bandwidth environments.

Third, the above-described exemplary embodiments of the device and method of the present invention make it easy to extract a separate low resolution video sequence, thereby enabling simultaneous display of multiple screens.

1. A device for playing back a scalable video stream, comprising:
a screen mode determination unit that determines a mode of a screen to be displayed;
a decoding level determination unit that determines a decoding level according to the screen mode;
a predecoder that provides a signal to be decoded in accordance with the decoding level;
a decoder that decodes the signal provided by the predecoder; and
a display unit that displays the decoded signal.

2. The device of claim 1, wherein the screen mode determination unit checks whether the screen mode is a main screen or a sub screen of a Picture-in-Picture (PIP).

3. The device of claim 1, wherein the screen mode determination unit checks a size of the screen.

4. The device of claim 1, wherein the decoding level determination unit determines the decoding level considering whether the quality of the screen coincides with a user's subjective perception of quality, and resolution and frame rate of the screen.

5. The device of claim 1, wherein the decoding level determination unit determines the decoding level in consideration of a resolution of the screen.

6. The device of claim 1, wherein the decoding level determination unit determines the decoding level in consideration of a playback speed of the screen.

7. A method for playing back a scalable video stream, comprising:
determining a mode of a screen to be displayed;
determining a decoding level suitable for the mode of the screen;
performing predecoding in order to provide a signal to be decoded according to the decoding level;
decoding the signal provided by the predecoder; and
displaying the decoded signal for playback.

8. The method of claim 7, wherein the decoding level is determined considering whether a quality of the screen coincides with a user's subjective perception of quality, and resolution and frame rate of the screen.

9. The method of claim 7, wherein the decoding level is determined in consideration of a resolution of the screen.

10. The method of claim 7, wherein the decoding level is determined in consideration of a playback speed of the screen.

11. The method of claim 7, wherein the displaying of the decoded signal for playback comprises:
inversely quantizing information on the decoded signal to obtain transform coefficients; and
performing inverse spatial and temporal transformation on the transform coefficients.
